(19) United States
(12) Patent Application Publication
(10) Pub. No.: US 2003/0118815 A1
(43) Pub. Date: Jun. 26, 2003

(54) Carbon nanostructures on nanostructures

(76) Inventors: Nelly M. Rodriguez, Mansfield, MA (US); R. Terry K. Baker, Mansfield, MA (US)

Correspondence Address: HENRY E. NAYLOR, 11750 S . HARRELLS FERRY RD, SUITE A, BATON ROUGE, LA, 70817, US

(21) Appl. No.: 10/261,334

(22) Filed: Sep. 30, 2002

Related U.S. Application Data
(63) Continuation-in-part of application No. 09/517,995, filed on Mar. 3, 2000.

(51) Int. Cl. D01F 9/12; B32B 1/00

(52) U.S. Cl. 428/368; 423/445 R; 423/447.2; 428/408; 428/399

(57) ABSTRACT

A nanostructure comprised of a primary layered non-cylindrical nanostructure support and at least one type of secondary substantially graphitic nanostructure grown therefrom. Both the primary layered nanostructure support and the layered substantially graphitic secondary nanostructure are substantially crystalline, wherein the secondary nanostructure, which will preferably be carbon, has a smaller diameter than the primary non-cylindrical nanostructure.

### CROSS-REFERENCE TO RELATED APPLICATIONS

This is a continuation-in-part of U.S. Ser. No. 09/517,995 filed Mar. 3, 2000.

### FIELD OF THE INVENTION

The present invention relates to a nanostructure comprised of a primary layered non-cylindrical nanostructure support and at least one type of secondary substantially graphitic nanostructure grown therefrom. Both the primary layered nanostructure support and the layered substantially graphitic secondary nanostructure are substantially crystalline, wherein the secondary nanostructure, which will preferably be carbon, has a smaller diameter than the primary non-cylindrical nanostructure.

### BACKGROUND OF THE INVENTION

Nanostructure materials, particularly carbon nanostructure materials, are quickly gaining importance for various potential commercial applications. Such applications include hydrogen storage, catalyst supports, battery components, and reinforcing components for polymeric composites. Carbon nanostructure materials are typically prepared from the decomposition of carbon-containing gases over selected catalytic metal surfaces at temperatures ranging from about 500° to 700° C.

For example, U.S. Pat. Nos. 5,149,584 and 5,618,875 to Baker et al. teach carbon nanofibers as reinforcing components in polymer reinforced composites. The carbon nanofibers alone can either be used as the reinforcing component, or they can be used as part of a structure comprised of carbon fibers having carbon nanofibers grown therefrom.

Also, U.S. Pat. No. 5,413,866 to Baker et al. teaches carbon nanostructures characterized as having: (i) a surface area from about 50 m²/g to 800 m²/g; (ii) an electrical resistivity from about 0.3 μuohm·m to 0.8 μohm·m; (iii) a crystallinity from about 5% to about 100%; (iv) a length from about 1 μm to about 100 μm; and (v) a shape that is selected from the group consisting of branched, spiral, and helical. These carbon nanostructures are taught as being prepared by depositing a catalyst containing at least one Group IB metal and at least one other metal on a suitable refractory support then subjecting the catalyst-treated support to a carbon-containing gas at a temperature from the decomposition temperature of the carbon-containing gas to the deactivation temperature of the catalyst.

U.S. Pat. No. 5,458,784 also to Baker et al. teaches the use of the carbon nanostructures of U.S. Pat. No. 5,413,866 for removing contaminants from aqueous and gaseous steams; and U.S. Pat. No. 5,653,951 to Rodriguez discloses and claims that hydrogen can be stored between layers of layered nanostructure materials. All of the above referenced US patents are incorporated herein by reference.

While various carbon nanostructures and their uses are taught in the art, there is still a need for additional improvements before such nanostructure materials can reach their full commercial and technical potential.

### SUMMARY OF THE INVENTION

In accordance with the present invention, there is provided a nanostructure comprised of a layered non-cylindrical primary nanostructure support and at least one layered substantially graphitic secondary carbon nanostructure grown therefrom. Both the primary nanostructure support and the secondary carbon nanostructure have a crystallinity from about 50% to about 100%, and wherein the secondary carbon nanostructure has a diameter that is smaller than that of the primary nanostructure.

In another preferred embodiment of the present invention the layered non-cylindrical primary nanostructure is selected from crystalline aluminosilicates and carbon nanostructures.

In a preferred embodiment of the present invention the layered non-cylindrical primary nanostructure is a carbon nanostructure characterized as having: (i) a surface area from about 0.2 to 3,000 m²/g, (ii) an electrical resistivity from about 0.17 μohm·m to 0.8 μohm·m, and (iii) a length up to about 100 mm.

In yet another preferred embodiment of the present invention the layered non-cylindrical primary nanostructure is a carbon nanostructure selected from the group consisting of multiwalled non-cylindrical carbon nanotubes, carbon nanoribbons, carbon nanoshells, and carbon nanofibers.

In still another preferred embodiment of the present invention the layered non-cylindrical primary nanostructure is a carbon nanofiber comprised of graphitic platelets disposed from about 30° to about 90° of the longitudinal axis of the nanofiber.

In other preferred embodiments of the present invention the resulting nanostructure of the present invention is incorporated into a polymeric matrix material selected from thermosets, thermoplastics, and elastomers.

### BRIEF DESCRIPTION OF THE FIGURES

FIG. 1(a) is a representation of what a branched carbon nanostructure would look like when grown from a single metal catalyst particle that fragments to result in branching at one end of the nanostructure. FIG. 1(b) is a representation of the secondary carbon nanostructure of primary nanostructure of the present invention showing secondary nanostructures grown along the body of the primary nanostructure.

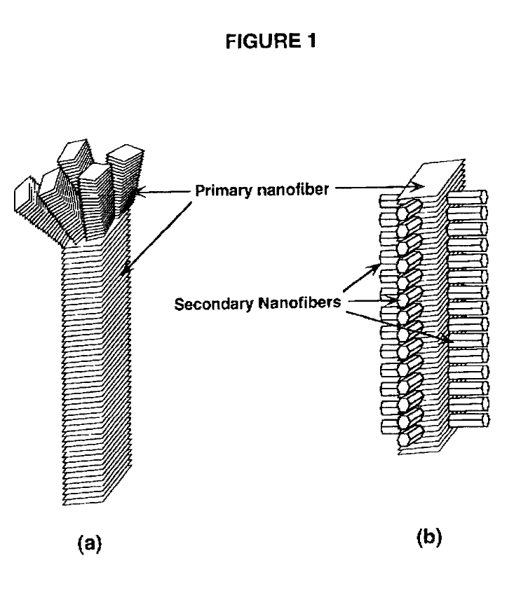

FIG. 2 hereof is a rough representation of the primary features of a layered non-cylindrical carbon nanotube that can be either the primary or secondary nanostructure of the present invention. This figure shows non-cylindrical multifaceted tubular containing a substantial amount of edge sites growing from a metal catalyst particle. A plurality of metal catalyst metal particles will be deposited onto the surface of a primary nanostructure from which a plurality of carbon nanostructures, in this figure, multifaceted tubular nanostructures. This figure also shows a tube within a tube structure.

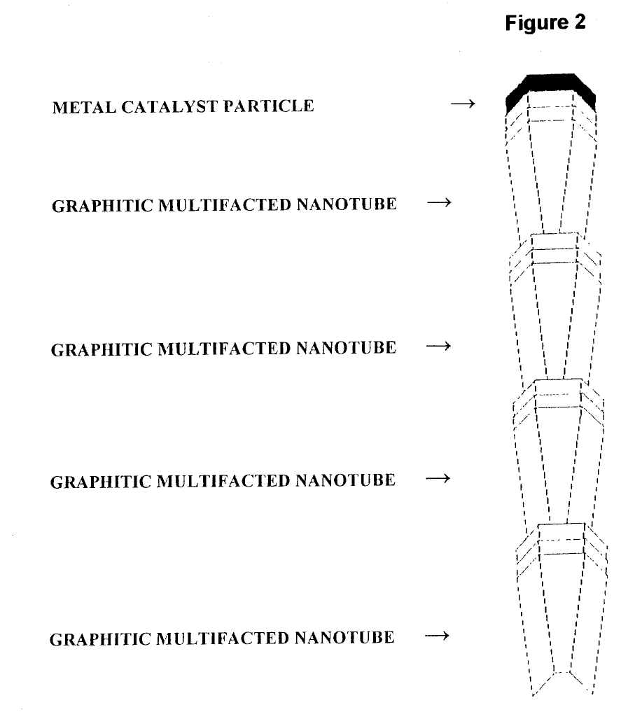

### DETAILED DESCRIPTION OF THE INVENTION

The propensity for carbon nanostructures to be formed during the interaction of hydrocarbons with hot metal surfaces is known. In recent years, it has been recognized that if one controls the growth and structural characteristics of carbon nanostructures by the use of selected catalysts, the carbonaceous material produced from such reactions displays a unique set of chemical and physical properties. The unique properties exhibited by nanostructured materials, coupled with the possibility of tailoring their dimensions, has an impact on research activities associated with carbon nanostructures, particularly those possessing a high graphite content, since such nanostructures have a variety of potential applications as mentioned above. The inventors named herein have discovered that growing carbon nanostructures from non-cylindrical nanostructure support materials, preferably having substantial crystallinity, results in unique nanostructure materials having unique properties. While the art teaches carbon nanostructures grown from various supports, including carbon fibers, carbon fibrils (cylindrical), metal oxides, and metal powders, there is no suggestion that they can unexpectedly be grown from non-cylindrical nanostructure supports, and result in product nanostructures having a complex structure and having unique properties, particularly those grown from the preferred non-cylindrical carbon nanofibers.

Non-cylindrical nanostructured supports that serve as the primary nanostructure herein include any layered refractory nano-size non-cylindrical support material having substantial crystallinity. By “layered” we mean that the nanostructure, which will preferably be graphitic will have at least one overlaying layer, similar to the physical structure of an onion that has onion skin overlaying onion skin. By “substantial crystallinity” we mean those materials that have a crystallinity greater than about 50%, preferably greater than about 75%, more preferably greater than 90%, and most preferably greater than 95%, especially substantially 100%. Non-limiting examples of such materials include crystalline aluminosilicates and graphitic carbon nanostructures, preferably layered carbon nanostructures. Non-limiting examples of preferred layered carbon nanostructure materials include multiwalled non-cylindrical carbon nanotubes, carbon nanoribbons, carbon nanoshells, and carbon nanofibers. The carbon nanofibers will typically be comprised of graphitic platelets that are disposed from about 30° to 90° of the longitudinal axis of the nanofiber. More preferred are carbon nanofibers comprised of graphitic platelets substantially perpendicular to that of the longitudinal axis of the nanofiber and those wherein the platelets are arranged in a herring-bone pattern with respect to the longitudinal axis. Most preferred are the carbon nanofibers wherein the platelets are perpendicular to the longitudinal axis.

The term multi-walled carbon nanotube refers to a carbon nanostructure which is multi-sided or multi-faceted. That is, the overall shape is still tubular but it is composed of a plurality of sides, somewhat like that of a multi-faceted pencil without the lead. It is preferred that the non-cylindrical multi-faceted tube have from 6 to 8 sides.

Carbon nanoribbons are those carbon structures in which the graphite platelets are aligned substantially parallel to the longitudinal axis and wherein at least about 95% of the edge sites are exposed. Carbon nanoshells, also sometimes referred to as carbon nanoparticles, are typically polyhedral layered structures comprised of multiple layers of carbon, forming substantially closed shells around voids or metal particles of various shapes and sizes. Such materials are described in an article entitled “Encapsulation Of Lanthanum Carbide In Carbon Nanotubes And Carbon Nanoparticles”, by Mingqui Liu and John M. Cowley; Carbon, Vol. 33, No. 2, pages 225-232; Elsevier Science Inc., 1995. For purposes of the present invention, a metal that is capable of dissociatively absorbing hydrogen, such as lanthanum and magnesium, is incorporated into the void, or hollow inner core of the carbon nanoshell.

While U.S. Pat. Nos. 5,578,543 and 5,589,152 teach carbon nanostuctures grown from cylindrical carbon fibrils, there is no suggestion that superior nanostructures can be obtained when secondary carbon nanostructures are grown from non-cylindrical nanostructures, especially layered non-cylindrical nanostructures. These unique and superior properties result from the great number of exposed edges that are characteristic of non-cylindrical carbon nanostructures, particularly the preferred carbon nanofibers as defined herein. These exposed edges lead to greater contact points when the resulting nanostructures are used in a matrix, such as a polymer matrix. The great number of exposed edges also leads to improved absorption capacity for gases, such as hydrogen. The exposed edges are also superior for the removal of organic components from water.

It is preferred that the primary non-cylindrical nanostructured support be substantially graphitic, and in the case of carbon nanofibers, the most preferred nanostructure, the interstices between graphitic platelets will be of a distance of about 0.335 nm to about 0.67 nm. Typically they will be comprised of graphitic platelets, which platelets will be disposed from about 30° to about 90° of the longitudinal axis of the nanofiber. It is more preferred when the platelets of the carbon nanofiber be disposed in a herring-bone or perpendicular pattern, with respect to the longitudinal axis of the nanofiber. It is most preferred when the graphitic platelets are substantially perpendicular to the longitudinal axis of the nanofiber.

Both the primary non-cylindrical nanostructure and the secondary carbon nanostructure can be further characterized as having: (i) a surface area from about 0.2 to 3,000 m²/g, (ii) an electrical resistivity from about 0.17 μohm·m to 0.8 μohm·m, and (iii) a length up to about 100 mm.

Catalysts suitable for growing the secondary carbon nanostructures from the primary nano structure of the present invention include Group VIII metals, preferably Fe and Ni-based catalysts. The catalysts are typically alloys or multi-metallics comprised of a first metal selected from the metals of Group IB of the Periodic Table of the Elements, and a second metal selected from the Group VIII metals Fe, Ni, Co, Zn, or mixtures thereof. Group IB metals are Cu, Ag, and Au. Preferred are Cu and Ag with Cu being the most preferred. The Group IB metals is present in an amount ranging from about 0.5 to 99 at. % (atomic %). For example, the catalyst can contain up to about 99 at. %, even up to about 70 at. %, or even up to about 50 at. %, preferably up to about 30 at. %, more preferably up to about 10 at. %, and most preferably up to about 5 wt. % copper, of Group IB metal with the remainder being a Group VIII metal, preferably nickel or iron, more preferably iron. Catalysts having a high copper content (70 at. % to 99 at. %) will typically generate nanofibers which are predominantly helical or coiled, and which have a relatively low crystallinity (from about 5 to 25%). Lower concentrations of copper, e.g., 0.5 to 30 at. % have a tendency to produce spiral and branched nanofibers, whereas a catalyst with about 30 to 70 at. %, preferably 30 to 50 at. % copper will produce predominantly branched nanofibers.

A third metal may also be present. Although there is no limitation with respect to what the particular third metal can be, it is preferred that it be selected from the group consisting of Ti, W, Sn and Ta. When a third metal is present, it is substituted for up to about 20 at. %, preferably up to about 10 at. %, and more preferably up to about 5 at. %, of the second metal. It is preferred that the catalyst be comprised of copper in combination with Fe, Ni, or Co. More preferred is copper in combination with Fe and Ni from an economic point of view. That is, a catalyst of which Fe is used in place of some of the Ni would be less expensive than a catalyst comprised of Cu in combination with only Ni.

The overall shape of the secondary carbon nanostructure will be any suitable shape. Non-limiting examples of suitable shapes include straight, branched, twisted, spiral, helical, coiled, and ribbon-like. The most preferred overall shape for hydrogen storage are the branched and straight secondary layered carbon nanostructures. It is to be understood that the graphite platelets of the secondary carbon nanostructure may have various orientations. For example, they may be aligned parallel, perpendicular, or at an angle with respect to the longitudinal axis of the secondary carbon nanostructure. Further, the surface area of the secondary carbon nanostructure can be increased by careful activation with a suitable etching agent, such as carbon dioxide, steam, or the use of a selected catalyst, such as an alkali or alkaline-earth metal.

The structural forms (orientation of platelets) of the secondary carbon nanostructures of the present invention can be controlled to a significant degree. For example, use of a catalyst that is comprised of only Fe will produce predominantly straight nanofibers having their graphite platelets substantially parallel to the longitudinal axis of the nanofibers. The distance between the platelets (the interstices) will be between about 0.335 nm and 0.67 nm, preferably from about 0.335 nm to 0.40 nm. It is most preferred, particularly for hydrogen storage, that the distance be as close to 0.335 nm as possible, that is, that it be substantially 0.335 nm.

The product nanostructure of the present invention where a secondary nanostructure is grown from a primary nanostructure is substantially different from a branched carbon nanostructure that starts its growth from a single catalyst particle. The carbon nanostructure that branches during growth is formed in a single spontaneous act wherein the structure of the branch is identical to the structure of the parent nanostructure since both originate from the same catalyst particle. The branching, which is an integral offshoot of the parent, results from fragmentation of the initial metal catalyst particle into a number of smaller particles, each of which produces a nanostructure. The branch only appears at one end of the parent and is thus restricted to only a single region on the parent nanostructure. The product nanostructures of the present invention are different from the above branched nanostructures because there will be a plurality of secondary nanostructures grown from a single primary nanostructure, instead of only at one end of a parent nanostructure, as with the branched nanostructures. The secondary nanostructures are not grown from the same initial catalyst particle as is the above referenced branched nanostructure. The product nanostructures of the present invention can be thought of as graft nanostructures wherein a secondary carbon nanostructure is grafted onto a primary nanostructure. The secondary carbon nanostructures will be structurally similar to each other and may or may not structurally similar to the primary nanostructure.

The product nanostructures of the present invention can be used in a matrix material, preferably a polymeric matrix material. Preferred polymeric materials include thermosets, thermoplastics, and elastomers. Non-limiting examples of suitable thermosets, thermoplastics and elastomers include polyurethanes, natural rubber, synthetic rubber, epoxy, phenolic, polyesters, polyamides, and silicones. Non-limiting examples of thermoplastics include polyacetal, polyacrylic, acrylonictrile-butadiene-styrene, polycarbonates, polystyrenes, polyethylene, styrene polybutylene terephthalate, nylons (6, 6/6, 6/10, 6/12, 11 and 12), polyamide-imides, polyarylates, polyurethanes, thermoplastic olefins, and the like. Non-limiting examples of thermoplastic elastomers suitable for use herein include: polyacetalpolyolefin type elastomers; styrene-type elastomers such as styrene-butadiene styrene block co-polymers and styrene-isoprene-butadiene styrene block co-polymers and their hydrogenated forms; PVC-type elastomers; urethane-type elastomers; polyester-type elastomers; polyamide-type elastomers; polybutadiene type thermoplastic elastomers, such as 1,2 polybutadiene resins and trans-1,4-polybutadiene; polyethylene-type elastomers such as methylcarboxylate-polyethylene co-polymers, ethylene-ethylacrylate co-polymers chlorinated polyethylene; fluorine type thermoplastic elastomers, etc. Other examples of suitable thermoplastics resins include epoxy bismaleimides, polyamide-imide(PAI), polyphenylene sulfide(PPS), polysulfone(PS), polyethesulfone(PES), polyetherimide(PEI), polyetheretherketone(PEEK), and polytetrafluoroethylene (PTFE).

The present invention will be illustrated by the following examples that are not to be taken as limiting in any way.

### EXAMPLES

Three different types of support materials were used for these examples. A first support material was a Cab-0-Sil amorphous fumed silica, a second support material was SP-1 Graphite from Alfa Aesar Corporation where the percent of exposed edge to basal plane area was about 5%, and a third support material was a “platelet” graphite nanofiber (P-GNF). The P-GNF material is characterized as having graphite platelets substantially perpendicular to the nanofiber longitudinal axis and wherein over about 99% of its edge sites were exposed. Prior to use, the P-GNF material was treated with 1M hydrochloric acid for about one week to remove remnants of iron catalyst used for its preparation. The characteristics of these three support materials are shown in Table I below.

TABLE I

| | Surface Area | Geometric | |
|---|---|---|---|
| Support | N₂ Bet m²/g | Properties | Electronic Properties |
| SiO₂ | 255 | Amorphous | Insulator |
| SP1-Graphite | 6 | ≈5% Edge Sites | Conductor in Basal |
| | | | Plane |
| P-GNF | 234 | ≈99% Edge Sites | Conductor in basal |
| | | | Semiconductor along |
| | | | edges |

Iron, cobalt, and nickel were used as catalysts and were separately introduced onto each of the graphitic supports via incipient wetness impregnation in ethanol using the respective metal nitrates as precursor salts to produce a 5 wt. % metal loading. The impregnated materials were all dried overnight in air at 110° C., followed by calcination in air at 350° C. for 4 hours, then reduced in 10% H₂/He at 350° C. for 24 hours. The silica supported catalyst system was prepared according to a similar protocol, except that they were treated for 36 hours in a 10% H₂/He stream at 350° C. in order to ensure complete reduction of the particles to the metallic state. All catalysts were cooled to room temperature, and passivated in 2% air/He for 2 hours prior to removal from the reactor. These treatments, and the subsequent carbon deposition reactions, were performed in a horizontal flow reactor system.

Carbon Nanofiber Growth Protocol

About 150 mg of a given catalyst sample was uniformly dispersed along the base of a ceramic boat and placed in the central region of a horizontal quartz reactor contained with a clam furnace. Initially, the catalyst was reduced for 2 hours in a 20% H₂/He stream at 600° C. to ensure that the passivated particles were converted to the metallic state. After flushing the system with 100 mL/min He at 600° C. for one hour, a 80/20 mL/min C₂H₄/H₂ reactant mixture (research grade) was introduced into the system. The composition of the reactant gas was analyzed at the start and at regular intervals during the reaction in a gas chromatography unit. Carbon and hydrogen atom balances in conjunction with the relative concentrations of the respective components were employed to calculate the solid carbon yields as a function of time. The reaction was allowed to proceed for 1.5 hours and at completion the system was cooled to room temperature with 100 mL/min He. The resulting solid product was weighed and stored for further characterization. In all cases the computed and measured weights of the solid carbon product were within ±5%.

Characterization Studies

The structural details of the solid carbon deposits were obtained from transmission electron microscopy (TEM) studies. An estimate of the overall degree of graphitic nature of the carbon deposit produced on the silica supported metal system was obtained from a comparison of the oxidation profile (weight loss as a function of reaction temperature) of the material in CO₂/Ar (1:1) with those found for two standards, single crystal graphite and amorphous carbon, when treated under the same conditions. The onset of gasification of active carbon occurs at 550° C., while the corresponding point for pure graphite is 860° C. In order to avoid ambiguities due to the presence of metallic impurities all samples were treated in 1M hydrochloric acid for a period of 1 week, a procedure that had previously been found to be very effective for the complete removal of the metal that could catalyze the oxidation of the carbon samples. This approach could not be utilized to examine the nature of the carbon deposits formed on either the graphite or P-GNF supported metal particles since it was not possible to discriminate between the oxidation characteristics of the respective materials.

Results

The percent yield of solid carbon was determined by the weight gain after reaction of the various catalyst systems in an ethylene/hydrogen (4:1) mixture for 90 minutes at 600° C. is shown in Table II below.

TABLE II

| | Support | | |
|---|---|---|---|
| Metal | SP1-Graphite | Silica | P-GNF |
| 5% Ni | 84.0 | 78.0 | 78.0 |
| 5% Co | 13.0 | 4.0 | 34.0 |
| 5% Fe | 20.0 | 19.0 | 69.0 |

This table shows that the yields of solid carbon were the highest for the P-GNF supported metals, followed by the corresponding SP1 graphite supported systems, with the lowest performance being achieved when silica was used as the supporting medium. Of particular significance is the observation of the relatively high yield of nanofibers found for the Fe/P-GNF system, since in the unsupported condition iron does not readily dissociate ethylene and as a consequence, exhibits a poor performance for the growth of carbon nanofibers. It is also apparent from Table II that the maximum amount of nanofibers was not only higher when the metal was dispersed on the P-GNF support, but the activity was maintained for a longer period in this system than when the same reaction was performed over either Fe/SP1 graphite or Fe/SiO₂ samples.

Characterization of the Solid Carbon Deposit

Examination of the samples of solid carbon in the transmission electron microscope indicated that in all cases the solid product consisted exclusively of carbon nanofibers. A typical width distribution of carbon nanofibers produced from the catalytic decomposition of ethylene/hydrogen (4:1) at 600° C. that was produced from the various catalyst systems is shown in Table III below.

TABLE III

| | Average Width (nm) | | | |
|---|---|---|---|---|
| Metal | SP1-Graphite | Silica | P-GNF | Unsupported |
| 5% Ni | 3-50 | 4-49 | 5-43 | 35-450 |
| 5% Co | 5-185 | 1-17 | 4-31 | 25-250 |
| 5% Fe | 4-35 | 5-33 | 5-150 | no nanofibers produced |

Examination of the values of Table III reveals that with the exception of the Co/graphite system, the size ranges of carbon nanofibers are similar from all the supported metal catalyst. In all the silica supported systems the metal particles were on average about 10 nm in size and it was difficult to discern the existence of any particular morphological characteristics. In contrast, metals dispersed on the graphite and P-GNF supports exhibited significant differences in both size and shape depending upon their location on the support.

Bimetallic Catalyst Systems

Two bimetallic systems, Fe—Ni and Fe—Cu were prepared from the respective metal nitrates, mixed in the desired ratios and introduced onto silica and P-GNF supports via aqueous and nonaqueous incipient wetness techniques, respectively to give a 5 wt % metal loading. The impregnated samples were calcined, reduced, and passivated. A similar procedure was followed for the preparation of supported 5 wt.5 iron catalysts. Carbon nanofibers were grown onto the supported catalyst system using CO/H₂ (4:1) feed gas at 550° C. in a flow reactor system. The gaseous products of the reaction were monitored with gas chromatography. The percent yield of solid carbon at various times was determined from mass balances of the reactants and products. The solid carbon products were characterized with a variety of techniques including high resolution transmission electron microscopy (HRTEM), BET surface area measurements based on nitrogen adsorption at −196° C. and temperature programmed oxidation. For these latter experiments carbon samples were demineralized by a treatment of 1M hydrochloric acid to remove exposed metal particles and thus preventing their participation in the gasification of carbon materials. Table IV present the data for this set of bimetallic catalysts.

TABLE IV

| | | Fe-Cu | Fe-Cu | Fe-Cu | Fe-Ni | Fe:Ni | Fe-Ni |
|---|---|---|---|---|---|---|---|
| Support | Fe | 8:2 | 5:5 | 2:8 | 8:2 | 5:5 | 2:8 |
| SiO₂ | 3.5 | 10.0 | 8.4 | 3.7 | 12.4 | 33.9 | 69.6 |
| P-GNF | 75.5 | 98.6 | 63.0 | 28.5 | 90.2 | 35.1 | 27.8 |

The data of Table IV evidences that the Fe—Cu catalysts generated solid carbon in a linear fashion, both supported bimetallic systems exhibiting a decrease in yield as the fraction of Cu in the particles was progressively raised. It is apparent that when the corresponding set of supported Fe—Ni catalysts were subjected to the same reaction conditions diverse patterns of behavior were observed. In this case, the silica supported Ni-rich catalysts generated the most carbon product, while on P-GNF, the Fe-rich was most efficient for carbon growth.

Examination of the solid products generated in these experiments revealed that carbon nanofibers were the exclusive form of carbon, however, the characteristics of the material were found to be extremely sensitive to the nature of the catalyst system. Nanofibers derived from the P-GNF supported Fe—Ni system were observed to be tubular in nature, having graphitic walls surrounding an amorphous or hollow core. These nanofibers were frequently twisted into different directions, but still maintained structural characteristics in that the graphite sheets were aligned parallel to the fiber axis. The material formed on bimetallic particles with a high iron content were highly crystalline and tended to be shorter in length than those formed on the nickel rich particles. In the latter case, the nanofibers adopted many of the features displayed by their unsupported counterparts with the individual graphitic platelets being arranged in a nest-like manner and aligned at a shallow angle (almost parallel) to the nanofiber axis.

Examination of the structural characteristics of nanofibers produced from the supported Fe—Cu systems showed that in both cases the graphite platelets constituting these materials acquired a “herring-bone” arrangement. As the iron content of the catalyst particles was increased, there was a tendency for the formation of narrower nanofibers, 3-10 nm in diameter. These smaller diameter nanofibers tended to the more flexible and had a less ordered structure than the larger ones.

A comparison of the structural characteristics of carbon nanofibers derived from the interaction of CO/H₂ with powered catalysts with those obtained from the same metal combinations dispersed on silica and P-GNF support media shows that major differences exist between the materials. It is clear in the latter systems the support imposes certain morphological restraints on the particles that are not present in the powered samples and these features are manifested in modifications in the degree of crystalline perfection and arrangement of the graphite sheets constituting the nanofibers. This behavior is particularly evident for the P-GNF supported metal particles where the uniform edge arrangement of the carbon atoms act as a template for the nucleation and growth of metal particles, which tend to acquire structures not normally encountered on traditional support media. Under these circumstances it is not unexpected that the metal particles dispersed on the P-GNF would exhibit different adsorption and reactivity characteristics compared to those displayed by the same metals on less structurally ordered supports, such as silica.

One of the best examples of this effect is seen from a comparison of the behavior of unsupported and supported iron with the CO/H₂ reactant. Previous work has demonstrated that the carbon nanofibers generated from the reaction of iron powders with the gas mixture were highly crystalline in nature. HRTEM examinations indicated that the nanofibers formed under the latter conditions acquired a very unique structure in which the graphite sheets were stacked in a direction perpendicular to the fiber axis. These structures were subsequently designated platelet graphite nanofibers, P-GNF. In the current investigation this material has been employed as the support for small iron particles, which was treated in the same CO/H₂ reactant mixture. Contrary to expectations, the structural characteristics of the secondary nanofibers did not parallel those of the primary, or parent, support structure, but instead consisted of graphite sheets that were oriented in a direction parallel to the fiber axis.

What is claimed is:

1. A nanostructure comprised of a layered non-cylindrical primary nanostructure support and a plurality of secondary carbon nanostructures grown therefrom wherein both said layered primary nanostructure support and said secondary carbon nanostructures have a crystallinity from about 50% to 100%, and wherein said secondary carbon nanostructures have diameters that is smaller than that of said primary nanostructure.

2. The nanostructure of claim 1 wherein the layered non-cylindrical primary nanostructure is selected from the group consisting of crystalline aluminosilicates, ceramics, and carbon nanostructures.

3. The nanostructure of claim 1 wherein the layered non-cylindrical primary nanostructure is a carbon nanostructure selected from the group consisting of carbon nanoribbons, non-cylindrical multifaceted nanotubes, carbon nanoshells, and carbon nanofibers.

4. The nanostructure of claim 3 which is a carbon nanofiber comprised of platelets that are disposed from about 30° to about 90° of the longitudinal axis of said carbon nanofiber.

5. The nanostructure of claim 4 wherein the carbon nanofiber is comprised of platelets that are substantially perpendicular to the longitudinal axis of said nanofiber.

6. The nanostructure of claim 1 wherein the layered non-cylindrical primary nanostructure is a carbon nanostructure further characterized as having: (i) a surface area from about 0.2 to 3,000 m²/g, (ii) an electrical resistivity from about 0.17 μohm·m to 0.8 μohm·m, and (iii) a length up to about 100 mm.

7. The nanostructure of claim 1 wherein the secondary carbon nanostructures are comprised of carbon nanofibers comprised of graphite platelets that are arranged substantially parallel to the longitudinal axis of the nanofiber.

8. The nanostructure of claim 1 which is further characterized in that both the primary and the secondary nanostructures are layered carbon nanostructures wherein at least 50% of the interstices between the layers is from about 0.335 nm and 0.67 nm.

9. The nanostructure of claim 9 wherein hydrogen is contained in at least a portion of the said interstices.

10. A composite material comprised of: a) nanostructure component comprised of a layered non-cylindrical primary nanostructure support and a plurality of secondary carbon nanostructures grown therefrom wherein both the primary nanostructure support and the secondary nanostructures have a crystallinity form about 50% to about 100%, and wherein said secondary nanostructures have diameters that are smaller than that of said primary nanostructure and wherein the secondary carbon nanostructure is further characterized as having: (i) a surface area from about 0.2 to 3,000 m²/g, (ii) an electrical resistivity from about 0.17 μohm·m to 0.8 μohm·m, and (iii) a length up to about 100 mm; and b) a polymeric matrix material.

11. The composite material of claim 10 wherein the polymeric matrix material is selected from thermosets, thermoplastics, and elastomers.
